(19) United States
(12) Patent Application Publication
(10) Pub. No.: US 2008/0212334 A1
(43) Pub. Date: Sep. 4, 2008

(54) Vehicle wheel solar powered lighting system

(76) Inventors: Kevin Hickman, Deerfield Beach, FL (US); Lester Hickman, Deerfield Beach, FL (US)

Correspondence Address: JAMES RAY & ASSOCIATES, 2640 PITCAIRN ROAD, MONROEVILLE, PA, 15146, US

(21) Appl. No.: 12/004,885

(22) Filed: Dec. 20, 2007

Related U.S. Application Data
(60) Provisional application No. 60/876,626, filed on Dec. 22, 2006.

(51) Int. Cl. B60Q 1/26; B60Q 1/00

(52) U.S. Cl. 362/500; 340/425.5

(57) ABSTRACT

A vehicle wheel lighting system powered by the sun including light emitting devices attached to the front of a wheel in an aesthetic array. The light emitting devices are powered by rechargeable batteries that are recharged by solar panels. The light emitting devices are activated by light sensors that sense ambient light for automatically energizing the light emitting devices in darkness. In addition to the vehicle lighting system's aesthetics, it also provides automatic lighting for the vehicle, which from the safety standpoint is beneficial when a vehicle is parked or stopped or moving.

### CROSS-REFERENCE TO RELATED APPLICATION

This is a continuation-in-part application of U.S. Provisional Application No. 60/876,626 filed Dec. 22, 2006, and claims the priority of said U.S. Provisional Application.

### BACKGROUND OF THE INVENTION

The present invention relates to vehicle wheels, and, in particular, to a vehicle wheel incorporating decorative and safety features. It is well know that customizing a vehicle with regard to the decorative aspect is a hobby and source of pride for many individuals. It is also well known that the wheels of the vehicle in addition to the vehicle itself are also given this same attention. Also, it is well known that vehicle lighting is an important aspect for safety when the vehicle is parked or stopped at a red light or when driving in darkness.

### SUMMARY OF THE INVENTION

A vehicle wheel lighting system powered by the sun is disclosed including a vehicle wheel including an outer wheel rim for mounting a tire and a number of spokes extending towards the center of the wheel. At least one control board is operatively affixed to the back of at least one of the spokes in predetermined position. A number of light emitting devices, preferably light emitting diodes, for emitting a number of discrete points of light in an aesthetic array is provided. The light emitting devices are operatively attached to the front of the spokes. The light emitting devices are connected in circuit with the at least one control board. At least one light sensor is included for sensing ambient light for automatically energizing the light emitting devices upon the light sensor sensing darkness. The at least one light sensor is operatively attached to the front of at least one of the wheel spokes and is connected in circuit with the at least one control board. At least one rechargeable battery is operatively attached to the back of at least one of the wheel spokes and is connected in circuit with the at least one control board. At least one solar panel for generating electricity for recharging the at least one rechargeable battery is included. The at least one solar panel is operatively attached to the wheel rim and connected in circuit with the at least one control board. With the present invention, upon the light sensor sensing darkness and energizing the light emitting devices in an aesthetic array and to simultaneously enhance the safety aspects of the vehicle by making the vehicle more visible in the darkness even with the vehicle's ignition in the lock position.

Preferably, each wheel spoke is provided with one of the light emitting devices which, for example, may be attached at an equal distance from the center of the wheel, for example, to form a pleasing aesthetic array when the light emitting devices are energized.

Desirably, one solar panel is operatively positioned on the rim near the base of each wheel spoke.

Also, it has been found to be expedient to attach a control panel to the back of each wheel spoke. Yet further, one of the rechargeable batteries is preferably attached to the back of each wheel spoke. And preferably, one light sensor is operatively attached to the front of each wheel spoke.

Desirably, the vehicle wheel lighting system of the present invention, further includes at least one on-off switch connected in circuit with the at least one control panel for overriding, if desired, the automatic energization of the at least one light emitting. The at least one on-off switch is attached to the back of the wheel. It has been found expedient to attach one of the on-off switches to the back of each wheel spoke with each on-off switch connected in circuit with the at least one control board.

### BRIEF DESCRIPTION OF THE DRAWINGS

For a better understanding of the invention reference may be had to the accompanying drawings exemplary of the invention, in which:

FIG. 1 is a schematic front view of a vehicle wheel carrying the lighting system of the present invention;

FIG. 2 is a schematic back view of a vehicle wheel carrying the lighting system of the present invention; and,

FIG. 3 is a schematic diagram of the electrical circuit of the vehicle wheel lighting system of the present invention.

### BRIEF DESCRIPTION OF THE ADVANTAGEOUS EMBODIMENTS

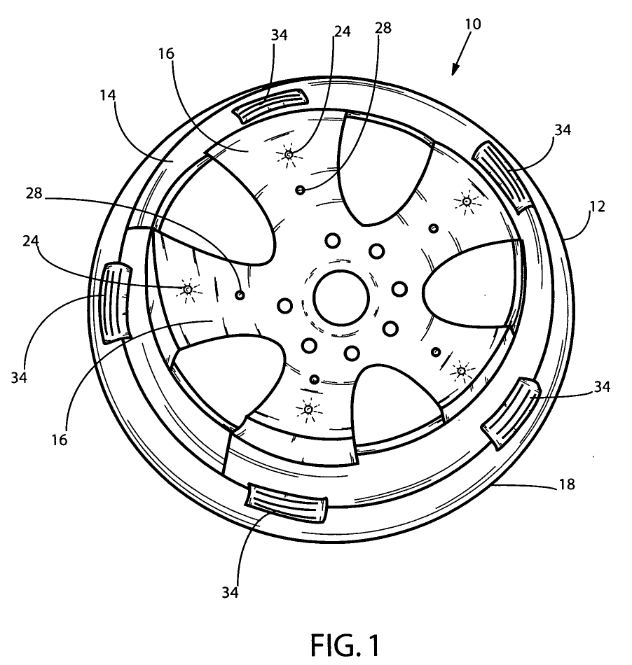

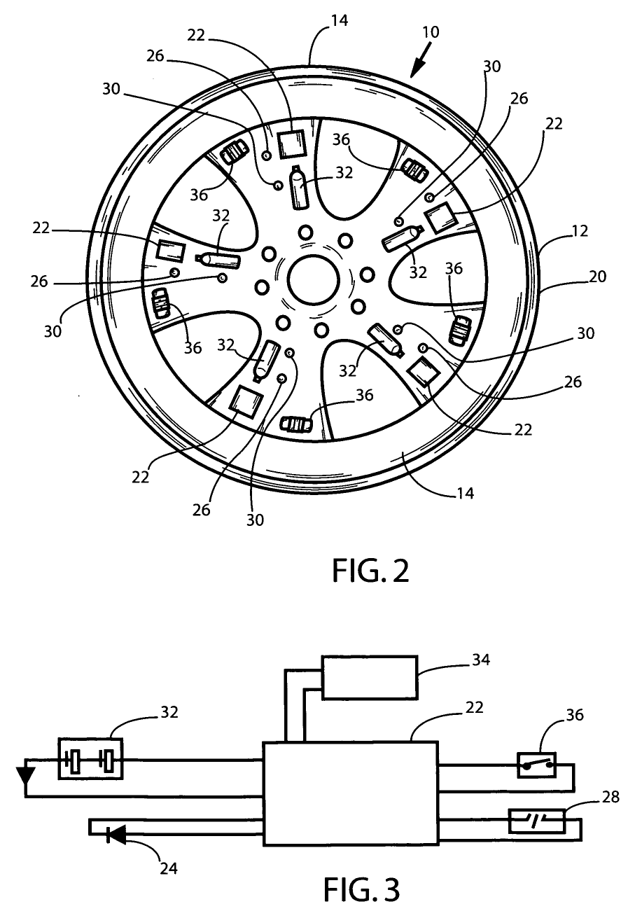

With reference to FIGS. 1-3, the vehicle wheel lighting system 10 of the present invention is shown. As shown in FIG. 1 the lighting system 10 includes a vehicle wheel 12 including an outer wheel rim 14 for mounting a tire. The wheel 10 includes a number of centrally extending spokes 16. The vehicle wheel 10 is typically a decorative-type of wheel of an alloy of aluminum or steel, for example, and may be covered with a chrome finish, as is well known. The wheel 12 has a front 18 and a back 20 At least one electronic control board 22 is operatively attached to the back 20 of the wheel 12 as shown in FIG. 2. The control board 22 may be, for example, a controller board available from Casual Solar Landscape Light model no. L4-12 and maybe attached to the back of the wheel by using a strong adhesive while hiding all wires. One or a number of controller boards 22 may be used as shown in FIG. 2. A number of light emitting devices 24, preferably light emitting diodes, LED'S, are operatively attached to the front of the spokes 16 in the position desired. First apertures 26 are provided through wheel 12, as shown in FIG. 2, sized to hold light emitting device 24 with adhesive so that the light emitting portion is firmly held in operative position on the front 18 of the wheel 12, the pair of wires for each light emitting device 24 passing through apertures 26. The wires from the light emitting device 24 is connected in circuit as shown in FIG. 3. The light emitting devices 24 emit points of light in an aesthetic array which can be arranged as desired. The light emitting devices 24 are connected in circuit with control board 22 as shown in FIG. 3. The light emitting devices 24 may be light emitting diodes as sold by Radio Shack which, for example, may be as follows: 5 mm—white LED part no. 276-320; 5 mm—blue LED part no. 276-311; 5 mm—red LED part no. 276-307; 5 mm—green LED part no. 276-304; and/or 5 mm blinking LED part no. 276-312.

With reference to FIGS. 1-3, at least one light sensor 28 for sensing ambient light for automatically energizing the light emitting devices 24 upon the light sensor 28 sensing darkness is included. The at least one light sensor 28 is operatively attached to the front 18 of at least one of the spokes 16 and connected in circuit with the at least one control board 22 as shown in FIG. 3. A number of light sensors 28, are preferably provided one for each wheel spoke 16. Second apertures 30 are provided through wheel 12, as shown in FIG. 2, sized to hold light sensors 28 with adhesive so that the light emitting portion is firmly held in operative position on the front 18 of the wheel 12, the pair of wires for each light sensor 28 passing through second apertures 30. The wires from the light sensor 28 is connected in circuit as shown in FIG. 3. The light sensor 28 may be positioned on each wheel spoke 16 as shown in FIG. 1. The light sensor 28 is connected in circuit with control board 22 as shown in FIG. 3. The light sensor 28 may be a photoresistor in a simple circuit, not shown, using a transistor and a relay to control the light emitting device 24. In an alternative arrangement the relay may be replaced by two transistors.

At least one rechargeable battery 32 is provided and operatively attached to the back 20 of the wheel 12 by an adhesive, for example, as shown in FIG. 2. The at least one rechargeable battery 32 is connected in circuit with the at least one control board 22 as shown in FIG. 3. The rechargeable battery 32 may be a standard 1.5 volt AA NiCad rechargeable battery, for example, Radio Shack part no. AACS2100. Preferably, a battery 32 is attached to each wheel spoke 12 as shown in FIG. 2.

At least one solar panel 34 for generating electricity for recharging the rechargeable battery 32 is included. The at least one solar panel 34 is operatively attached, by adhesive for example, to the front 18 of the wheel 12 on the rim 14. The solar panel 34 is connected in circuit with the control board 22. Wires from the solar panel 34 may pass through third apertures, not shown, to the control board 22 on the back 20 of the wheel 12. Preferably, one solar panel 34 having the dimensions of 2 inches by 2 inches, for example, is operatively positioned on the rim 14 at the base of each wheel spoke 16 as shown in FIG. 1. The solar panels 34 are positioned on the wheel to maximize light reception.

At least one manual on-off switch 36 is provided and connected in circuit with at the at least one control panel 22 for overriding the automatic energization of the at least one light emitting device 24 as shown in FIG. 3 as desired. The on-off switch 36 can be attached by adhesive to the back 20 of the wheel 12. Preferably, the back 20 of each wheel spoke 16 has attached one of the on-off switches 36.

In a preferred embodiment, the solar panels 34 are wired directly to the batteries 32 through a diode, not shown, which prevents the battery's current from flowing back through the solar panel at night. The NiCad battery 32 produces about 1.2 volts and can store about 700 milliamp per hour. During the day the battery 32 charges, reaching a maximum charge except on shorter winter days or days when there is heavy overcast. At night the solar panels 34 stop producing power. The light sensor 28 turns on a light emitting device 24 at night or in darkness. When battery 32 is fully charged the light emitting device 24, LED, will shine for up to 15 hours. Also, since the LED's used draw about 45 milliamps and with battery 32 producing 1.23 volts which produces 0.55 watts thereby providing the LED's with enough power so they will be bright enough to be seen easily. When the vehicle is parked or stopped at night the light emitting devices 24 appear as points of light, as the vehicle starts moving and increases speed the points of light will appear as a ring or rings of light depending on the positioning of the light emitting devices 24 and the speed of the vehicle.

What is claimed is:

1. A vehicle wheel lighting system comprising:
a vehicle wheel including an outer wheel rim for mounting a tire and having a plurality of centrally extending spokes, said wheel having a front and a back,
at least one control board operatively affixed to the back of at least one of said spokes,
a plurality of light emitting devices for emitting a plurality of discrete points of light operatively affixed to the front of said spokes in predetermined position, said light emitting devices for emitting points of light in an aesthetic array visible in darkness on said wheel when the vehicle is stationary, said light emitting devices connected in circuit with said at least one control board,
at least one light sensor for sensing ambient light for automatically energizing said light emitting devices upon said light sensor sensing darkness, said at least one light sensor operatively affixed to the front of at least one of said spokes and connected in circuit with said at least one control board,
at least one rechargeable battery operatively affixed to the back of at least one of said spokes and connected in circuit with said at least one control board,
at least one solar panel for generating electricity for recharging said at least one rechargeable battery, said at least one solar panel operatively affixed to said rim and connected in circuit with said at least one control board,
whereby upon said light sensor sensing darkness and energizing said light emitting devices in an aesthetic array to simultaneously enhance the safety aspects of the vehicle by making the vehicle more visible in the darkness even with the vehicle's ignition in the lock position.

2. The vehicle wheel lighting system of claim 1, wherein said light emitting devices are light emitting diodes.

3. The vehicle wheel lighting system of claim 1, wherein each spoke of said wheel has one of said light emitting devices affixed thereto at an equal distance from the center of the wheel to form said aesthetic array.

4. The vehicle wheel lighting system of claim 1, wherein one of said solar panels is operatively positioned on said rim at the base of each spoke of said wheel.

5. The vehicle wheel lighting system of claim 1, wherein one of said control panels is affixed to the back of each spoke of said wheel.

6. The vehicle wheel lighting system of claim 1, wherein one of said batteries is affixed to the back of each spoke of said wheel.

7. The vehicle wheel lighting system of claim 1, wherein one of said light sensors is operatively affixed to the front of each spoke of said wheel.

8. The vehicle wheel lighting system of claim 1, further comprising at least one on-off switch connected in circuit with said at least one control panel for overriding the automatic energization of said at least one light emitting device, said at least one on-off switch affixed to the back of said wheel.

9. The vehicle wheel lighting system of claim 8, wherein the back of each spoke of said wheel has one of one of said on-off switches affixed thereto and connected in circuit with said at least one control board.
